(19) United States
(12) Patent Application Publication
(10) Pub. No.: US 2005/0019224 A1
(43) Pub. Date: Jan. 27, 2005

(54) Virtual well plate system

(75) Inventors: David S. Pechter, Trenton, NJ (US); Edward G. Varga, Union, NJ (US)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(73) Assignee: Schering Corporation

(21) Appl. No.: 10/867,586

(22) Filed: Jun. 14, 2004

Related U.S. Application Data
(60) Provisional application No. 60/478,801, filed on Jun. 16, 2003.

(51) Int. Cl. B01L 3/00

(52) U.S. Cl. 422/102

(57) ABSTRACT

A virtual well plate system includes a base including a base plate having an upper surface with a hydrophobic region which defines hydrophilic domains, each hydrophilic domain adapted to hold a droplet of liquid therein; a movable lid including a lid plate having a lower surface with a hydrophobic region which defines hydrophilic domains, each hydrophilic domain adapted to hold a liquid droplet in a hanging manner; and a resistance arrangement mounted to the base and/or lid and which maintains the base and lid in an assembled condition such that the base plate and lid plate are maintained at a sufficient distance to prevent formation of virtual wells by the droplets, and which permits movement of the lid toward the base upon application of an external force sufficient to overcome a resistance of the resistance arrangement, to form virtual wells by combining the droplets.

This application claims the benefit of U.S. provisional patent application No. 60/478,801, filed Jun. 16, 2003, which is herein incorporated by reference in its entirety.

### BACKGROUND OF THE INVENTION

The present invention relates generally to a virtual well plate system that orders and retains fluid drops in a defined spatial array, and more particularly, to a virtual well plate system that permits accurate and controlled joining of the plates to create the desired virtual wells.

Because of the large volumes of data, compounds and targets, screening laboratories are required to work faster than ever in order to develop new products for market. Therefore, it is necessary to use a high-throughput screening system that delivers accurate data at a fast rate.

In order to better aid in such processes, a virtual well plate system was developed, which is the subject matter of published International Application No. WO 99/39829 (PCT/US99/02300) entitled VIRTUAL WELLS FOR USE IN HIGH THROUGHPUT SCREENING ASSAYS by Tina Garyantes, the entire disclosure of which is incorporated herein by reference. Basically, microliter-like plates containing virtual wells formed by an arrangement of relatively hydrophilic domains within relatively hydrophobic fields are provided. Assay mixtures are confined to the hydrophilic domains of the virtual wells by the edges of the hydrophobic fields.

Specifically, an array of droplets is confined to the hydrophilic domains within the hydrophobic field on a glass plate. Surface tension holds the droplets on the plates. In particular, there is a base and a lid, each typically having a 1536 well array of hydrophilic spots on a hydrophobically masked glass slide. The glass slides are each framed to enable controlled docking of the lid on the base. Thus, when the base and lid are assembled together, the glass plates of each are brought into close proximity with each other, whereby the aligned droplets touch to create short liquid columns or virtual wells. The hydrophobic masked regions surrounding each virtual well ensures that the liquid stays in each well and does not migrate or travel to adjacent virtual wells. Such virtual well plate systems are well known, and for example, sold by Becton, Dickinson and Company, 1 Becton Drive, Franklin Lakes, N.J. 07417 under the trademark FALCON.

The use of virtual wells is a versatile platform for biochemical and cell-based assays, and provides distinct advantages. Specifically, the use of virtual wells permits homogeneous and high throughput screening of assays with assay mixtures having volumes on the order of about 100 nl to 10 μl, while also providing a means for easily moving fluids. This provides an extremely flexible and efficient general assay platform that can be used with, for example, a wide variety of fluorescence and luminescence-based detection modes, with minimal waste of compounds.

However, a problem with such known virtual well system is in regard to the assembly of the lid on the base to form the virtual wells. In such case, it is necessary to either manually combine the lid and base or to use expensive and complicated robotics. This is because it is necessary to maintain the glass plates of the lid and base apart a sufficient distance so that the droplets do not combine to form the columns prior to the desired time. Therefore, since the glass plates must generally be kept separate and apart from each other, this further adds to the burden of preparation, storage and assembly of the lid and base.

Further, existing virtual well plates are not directly applicable to kinetic read assays such as the Fluorometric Imaging Plate Reader system sold under the trademark AFLIPR@ by Molecular Devices Corporation, 1311 Orleans Avenue, Sunnyvale, Calif. 94089-1136 FLIPR. The AFLIPR@ and similar systems available from CyBio AG, Göschwitzer Straβe 40, D-07745 Jena, Germany, and Hamamatsu Corporation, U.S.A., 360 Foothill Road, Bridgewater, N.J. 08807-0910, include integrated pipetting to enable kinetic read assays. These are assays whose response rapidly follows the addition of a stimulant, typically an agonist, and where the time course of that response needs to be recorded from its onset through the peak response and resolution of the response.

However, the two plate virtual well plate system of prior art is a closed system in that the upper plate blocks any further addition by pipettes from above. Further addition by pipettes, such as on the AFLIPR@ system, would require the use of a single plate system, which in practice would be simply a low volume microplate.

The two plate virtual well plate could be used if the lid and base were delivered separately to the AFLIPR@ system. This would require additional plate loading robotics, and a system to keep the plates separate after the door is closed to reduce ambient light.

### SUMMARY OF THE INVENTION

Accordingly, it is an object of the present invention to provide a virtual well plate system that overcomes the aforementioned problems.

It is another object of the present invention to provide a virtual well plate system that provides an accurate and controlled arrangement for preassembling a base and lid, each containing liquid-filled virtual wells without the contents of those wells joining to form columnar virtual wells, that is, the plates are assembled but not in close proximity, and a mechanism or kinematic system integral to the plate system allowing the plates carrying those virtual wells to be brought into close proximity by an external force or actuation.

It is still another object of the present invention to provide a virtual well plate system that maintains the base and lid in a spaced apart, but assembled condition, ready for formation of the virtual wells upon the application of an external force to the lid.

It is yet another object of the present invention to provide a virtual well plate system which can use a conventional pipette head or similar mechanism to move the glass plate of the lid into close proximity with the glass plate of the base to form the virtual wells, without the use of specialized robotic equipment.

It is a further object of the present invention to provide a virtual well plate system that provides near simultaneous formation of all 1536 wells.

It is a still further object of the present invention to provide a virtual well plate system that provides lateral alignment of the glass plate of the lid relative to the glass plate of the base to form the virtual wells.

It is a yet further object of the present invention to provide a virtual well plate system that can be used in an automated system.

It is another object of the present invention to provide a virtual well plate system that can simultaneously deliver 384, 1536 or higher well counts.

It is still another object of the present invention to provide a virtual well plate system in which no tip washing is required to avoid cross contamination of samples.

It is yet another object of the present invention to provide a virtual well plate system the spring-separated virtual well plate is compatible with the existing AFLIPR@ system without additional robotics, that is, without any re-engineering, although slight add-ons can be made to optimize the compatibility

It is a further object of the present invention to provide a virtual well plate system in which plate separation is inherent.

It is a further object of the present invention to provide a virtual well plate system in which even one microliter additions, which would be difficult with disposable pipette tips, are very reliable with the two plate virtual well plate system of the present invention.

In accordance with an aspect of the present invention, a virtual well plate system includes a base including a base plate having an upper surface with a hydrophobic region which defines a plurality of hydrophilic domains on the upper surface of the base plate, each hydrophilic domain adapted to hold a droplet of liquid therein; a movable lid including a lid plate having a lower surface with a hydrophobic region which defines a plurality of hydrophilic domains on the lower surface of the lid plate, each hydrophilic domain of the lid plate adapted to hold a droplet of liquid therein in a hanging manner; and a resistance arrangement mounted to at least one of the base and the lid which maintains the base and lid in an assembled condition such that the base plate and lid plate are maintained at a sufficient distance to prevent formation of virtual wells by the droplets thereon, and which permits movement of the lid toward the base upon application of an external force sufficient to overcome a resistance of the resistance arrangement in order to form the virtual wells by a combination of the droplets on the base plate and the lid plate.

In one embodiment, the resistance arrangement includes springs which support the movable lid above the base. In a particular example of this embodiment, a stationary lid is mounted to the base, and the springs are connected between the stationary lid and the movable lid for supporting the movable lid above the base. These springs can be coil, leaf or other spring elements. In such case, the stationary lid includes at least one opening through which an external pressing device can be inserted for biasing the movable lid toward the base against the force of the springs. In another example of this embodiment, the base includes upstanding side walls, and the springs include coil springs connected between upper ends of the side walls and the movable base.

In another embodiment, the resistance arrangement includes a deformable spacer between the lid and the base.

The deformable spacer can be a resilient member. As one example, the deformable spacer includes springs positioned between the base and the lid. The springs can be connected to the base or the lid, and can, for example, be cantilevered leaf springs. The cantilevered leaf spring can be positioned between the base and the lid when the lid is moved toward the base by the external force, so as to maintain the base plate and the lid plate separated by a predetermined distance sufficient to form the virtual wells. Alternatively, the base can include a recess for receiving the deformable spacer.

The deformable spacer can alternatively be a non-resilient member. As one example, the non-resilient member can be a crushable member which is crushed when the external force is applied to the lid. The crushable member can include slits for permitting easy crushing thereof.

In one embodiment, the base includes peripheral flanges having upper surfaces, and the base plate includes an upper surface which is positioned lower than the upper surfaces of the peripheral flanges such that, when the lid is moved by the application of the external force sufficient to overcome the resistance of the resistance arrangement, the peripheral flanges maintain a lower surface of the lid plate at a predetermined distance from the upper surface of the base plate for formation of the virtual wells. The peripheral flanges can include recesses in the upper surfaces thereof for holding the resistance arrangement and for permitting the resistance arrangement to collapse entirely in the recesses such that the lid rests on the upper surfaces of the peripheral flanges when the lid is moved by the application of the external force sufficient to overcome the resistance of the resistance arrangement.

Preferably, the base includes upstanding side walls and the lid is slidably positioned within the upstanding side walls. In such case, the resistance arrangement can include first detents on inner surfaces of the upstanding side walls and second detents on outer surfaces of the lid for engagement with the first detents such that the first detents support the lid plate at a sufficient distance from the base plate to prevent formation of the virtual wells by the droplets thereon, and which permit movement of the lid plate toward the base plate upon application of an external force sufficient to overcome resistance of the second detents riding over the first detents in order to form the virtual wells by a combination of the droplets on the base plate and the lid plate. In one example, there are two substantially vertically aligned first detents and one second detent which is captured between the two first detents to maintain the lid plate at a sufficient distance from the base plate to prevent formation of the virtual wells by the droplets thereon.

In another embodiment, the resistance arrangement includes at least one laterally movable spring biased element mounted to the base for applying a lateral force to the lid to maintain the lid plate at a sufficient distance from the base plate to prevent formation of the virtual wells by the droplets thereon and to also laterally align the lid plate relative to the base plate, and which permits movement of the lid plate toward the base plate with the lateral alignment upon application of an external force sufficient to overcome resistance of the laterally movable spring biased element in order to form the virtual wells by a combination of the droplets on the base plate and the lid plate.

In one embodiment, the base includes upstanding side walls, and each laterally movable spring biased element includes a cam lever pivotally mounted to at least one upstanding side wall and a spring for biasing the cam lever inwardly of the base. Each upstanding side wall to which at least one cam lever is pivotally mounted includes at least one opening therein, and each cam lever is pivotally mounted to the base and is positioned in a respective opening. Preferably, each cam lever includes a first detent on an inner facing surface thereof, and the lid includes at least one second detent on an outer facing surface thereof for engagement with each first detent.

In another embodiment, each laterally movable spring biased element includes a guide plate and springs which bias the guide plate inwardly of the base in a lateral direction so as to maintain the base and lid in an assembled condition by the force of the guide plate on the lid such that the base plate and lid plate are maintained at a sufficient distance to prevent formation of the virtual wells by the droplets thereon, and which permits movement of the lid plate toward the base plate upon application of an external force sufficient to overcome frictional resistance between the guide plate and the lid in order to form the virtual wells by a combination of the droplets on the base plate and the lid plate.

In still another embodiment, the base includes upstanding side walls, with at least one upstanding side wall including an opening therein, and each laterally movable spring biased element includes a cantilevered leaf spring hinged to the base and positioned in a respective opening. A wedge element is provided on an outer surface of the lid in association with each cantilevered leaf spring such that downward movement of the lid by the external force causes engagement between each cantilevered leaf spring and associated wedge to laterally move the lid plate into lateral alignment with the base plate.

In yet another embodiment, each laterally movable spring biased element includes an upstanding cantilevered leaf spring having an inwardly bowed configuration and extending upwardly from the base between the upstanding side wall of the base and the lid for laterally biasing the lid when the lid plate is moved toward the base plate.

Preferably, the base includes a plurality of connected upstanding side walls, and there are a plurality of the laterally movable spring biased elements mounted to two adjacent upstanding side walls for laterally aligning the lid relative to the base.

The above and other objects, features and advantages of the invention will become readily apparent from the following detailed description thereof which is to be read in connection with the accompanying drawings.

### BRIEF DESCRIPTION OF THE DRAWINGS

FIG. 1 is a side elevational view of a spaced apart base and a lid of a conventional virtual well plate system;

FIG. 2 is a side elevational view of the assembled base and lid of the conventional virtual well plate system;

FIG. 3 is a perspective view of the base/lid of the conventional virtual well plate system;

FIG. 4 is a vertical cross-sectional view of a virtual well plate system according to a first embodiment of the present invention, with the lower movable lid and base separated from each other;

FIG. 5 is a vertical cross-sectional view of the virtual well plate system of FIG. 4, with the lower movable lid and base in an assembled condition;

FIG. 6 is a top plan view of the base;

FIG. 7 is a cross-sectional view of the base of FIG. 6, taken along line 7-7 thereof;

FIG. 8 is a cross-sectional view of the base of FIG. 6, taken along line 8-8 thereof;

FIG. 9 is a top plan view of the lower movable lid;

FIG. 10 is an end elevational view of the lower movable lid;

FIG. 11 is a top plan view of the upper stationary lid;

FIG. 12 is an end elevational view of the upper stationary lid;

FIG. 13 is a side elevational view of the upper stationary lid;

FIG. 14 is a vertical cross-sectional view of a virtual well plate system according to a modification of the virtual well plate system of FIG. 4;

FIG. 15 is a vertical cross-sectional view of a portion of a virtual well plate system according to a second embodiment of the present invention;

FIG. 16 is an enlarged cross-sectional view of the virtual well plate system according to a modification of the virtual well plate system of FIG. 15, with the upper and lower glass plates spaced apart to prevent formation of the virtual wells;

FIG. 17 is an enlarged cross-sectional view of the virtual well plate system of FIG. 16 with the upper and lower glass plates spaced sufficiently close to form the virtual wells;

FIG. 18 is an enlarged cross-sectional view of the virtual well plate system according to the second embodiment of the present invention, in which the deformable spacer is formed by a cantilevered leaf spring connected to the base;

FIG. 18A is an enlarged cross-sectional view of the virtual well plate system according to the second embodiment of the present invention, in which the deformable spacer is formed by a cantilevered leaf spring connected to the lid and which seats in a recess in the base;

FIG. 19 is an enlarged cross-sectional view of the virtual well plate system according to the second embodiment of the present invention, in which the deformable spacer is formed by a coil spring;

FIG. 20 is an enlarged cross-sectional view of the virtual well plate system according to the second embodiment of the present invention, in which the deformable spacer is formed by a cantilevered leaf spring connected to the lid and which forms a spacer between the glass plates;

FIG. 21 is an enlarged cross-sectional view of the virtual well plate system according to a third embodiment of the present invention, in which the deformable spacer is formed by an irreversible deformable projection;

FIG. 22 is an enlarged cross-sectional view of the virtual well plate system according to the third embodiment of the present invention, in which the deformable spacer is formed by an irreversible deformable projection in the shape of a Chinese lantern;

FIG. 23 is an enlarged cross-sectional view of the virtual well plate system of FIG. 22, with the Chinese lantern projection in a crushed state;

FIG. 24 is an enlarged cross-sectional view of the virtual well plate system according to the third embodiment of the present invention, in which the deformable spacer is formed by an irreversible deformable projection in the shape of a slitted hemispherical dome;

FIG. 25 is an enlarged cross-sectional view of the virtual well plate system of FIG. 24, with the slitted hemispherical dome in a crushed state;

FIG. 26 is an enlarged cross-sectional view of the virtual well plate system according to a fourth embodiment of the present invention, in which the frame of the lid is formed with break-away tabs;

FIG. 27 is an enlarged cross-sectional view of the virtual well plate system of FIG. 26, with the tabs broken away and the lid in the lowered position;

FIG. 28 is an enlarged cross-sectional view of the virtual well plate system according to a fifth embodiment of the present invention, in which the lid is in a raised position;

FIG. 29 is an enlarged cross-sectional view of the virtual well plate system of FIG. 28, in which the lid is in a lowered position;

FIG. 30 is a vertical cross-sectional view of a virtual well plate system according to a sixth embodiment of the present invention, with the lid held in the uppermost position by the cam lever;

FIG. 31 is a vertical cross-sectional view of the virtual well plate system according to the sixth embodiment of the present invention, with the lid just passing by the cam lever;

FIG. 32 is a vertical cross-sectional view of the virtual well plate system according to the sixth embodiment of the present invention, with the lid already passed by cam lever and held on the base;

FIG. 33 is a perspective view of a modification of the virtual well plate system according to the sixth embodiment, using cantilevered leaf springs and wedges;

FIG. 34 is a vertical cross-sectional view of a modification of the virtual well plate system according to the sixth embodiment, using coil springs;

FIG. 35 is a vertical cross-sectional view of a modification of the virtual well plate system according to the sixth embodiment, using a leaf spring;

FIG. 36 is a top perspective view of an outer frame or base of a virtual well plate system according to a modification of the present invention;

FIG. 37 is a bottom perspective view of the outer frame of FIG. 36;

FIG. 38 is a top perspective view of an inner frame or lid for use with the base of FIG. 36;

FIG. 39 is a bottom perspective view of the inner frame of FIG. 38;

FIG. 40 is a perspective, partially cut-away view of a virtual well plate system according to a modification of the present invention;

FIG. 41 is perspective, cross-sectional view taken along line 41-41 of FIG. 40, showing the movable lid in the raised position;

FIG. 42 is perspective, cross-sectional similar to FIG. 41, showing the movable lid in the lowered position;

FIG. 43 is an exploded perspective view of the virtual well plate system of FIG. 41;

FIG. 44 is a partially exploded perspective view of the virtual well plate system of FIG. 41; and

FIG. 45 is a perspective view of the lower lid of the virtual well plate system of FIG. 41.

### DETAILED DESCRIPTION

Referring to the drawings, and initially to FIGS. 1-3, a known virtual well plate system 10 includes a base 12 and a lid 14, each including a glass plate 16 provided in a metal or plastic frame 18 to enable controlled docking of lid 14 on base 12. A hydrophobic field 20 is provided on each glass plate 16 to define a plurality of, for example, 1536, hydrophilic domains 22. An array of droplets 24 is confined to hydrophilic domains 22 within hydrophobic field 20 on each glass plate 16. Surface tension holds droplets 24 on glass plates 16.

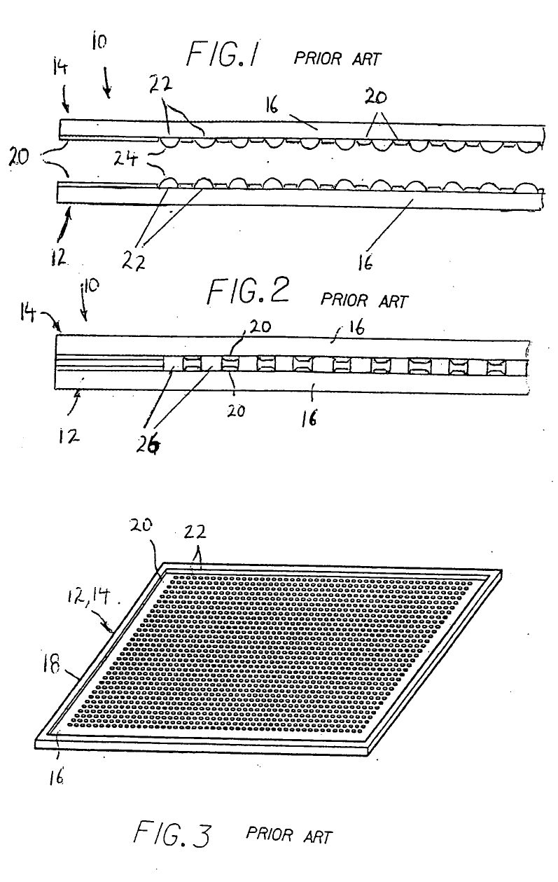

When base 12 and lid 14 are assembled together, as shown in FIG. 2, the glass plates 16 of each are brought into close proximity with each other, for example, to a distance of 0.85 mm, whereby the aligned droplets 24 on the lower surface of the lid glass plate and on the upper surface of the base glass plate, touch to create short liquid columns or virtual wells 26. A hydrophobic field 20 surrounding each virtual well 26 ensures that the liquid stays in each virtual well 26 and does not migrate or travel to adjacent virtual wells 26.

However, as discussed above, a problem with such known virtual well plate system 10 is with regard to the assembly of the base 12 and lid 14 to form virtual wells 26. In such case, it is necessary to either manually combine base 12 and lid 14, or to use expensive and complicated robotic equipment. This is because it is necessary to maintain base 12 and lid 14 apart a sufficient distance so that droplets 24 do not combine to form columns or virtual wells 26 prior to the desired time. Therefore, base 12 and lid 14 must generally be kept separate and apart from each other, which further adds to the burden of preparation, storage and assembly thereof.

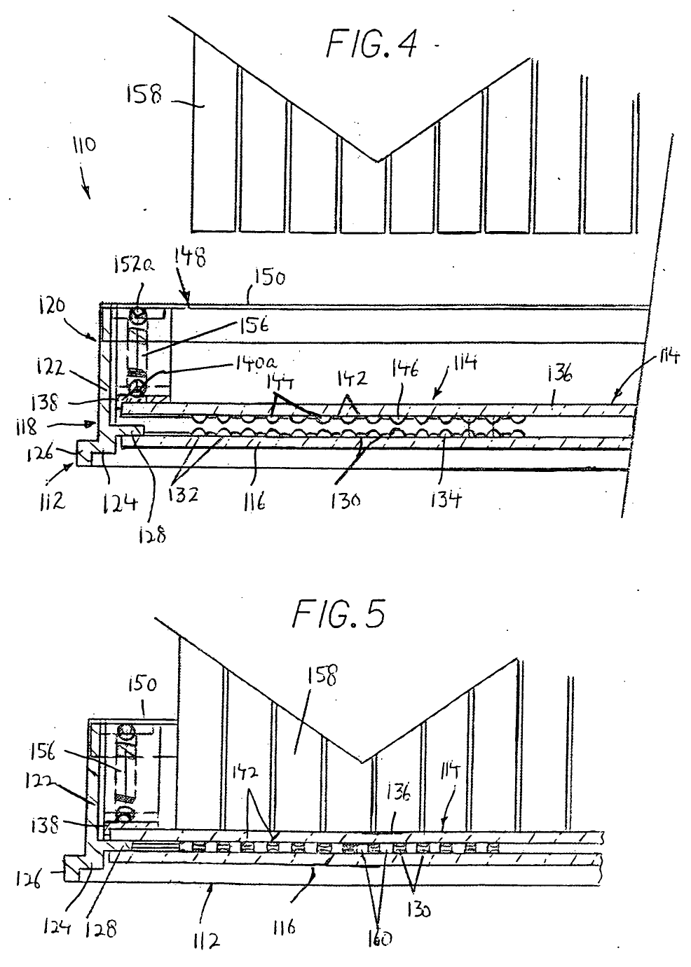

Referring now to FIG. 4, a virtual well plate system 110 according to a first embodiment of the present invention that solves the problems associated with virtual well plate system 10, will now be discussed.

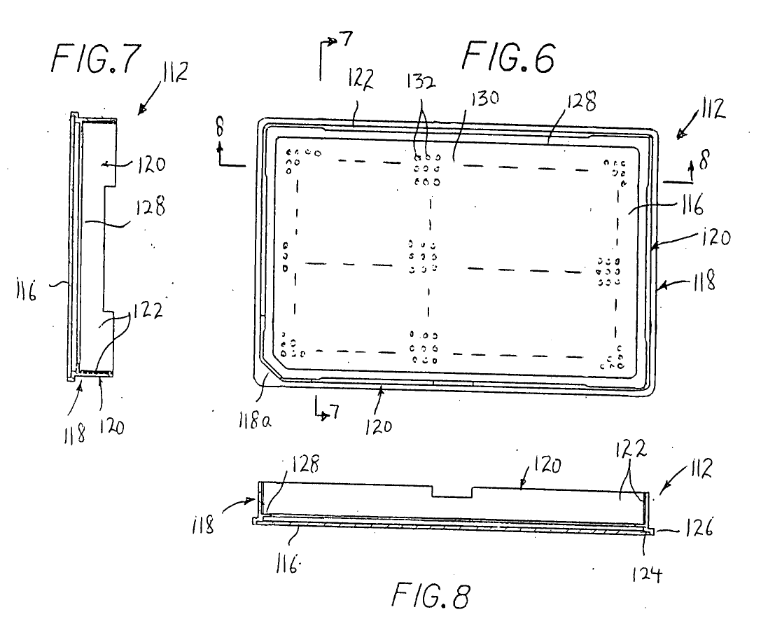

As with virtual well plate system 10, virtual well plate system 110 includes a base 112 having a glass plate 116 provided in a frame 118 made of any suitable material, including but not limited to a metal such aluminum or steel, a plastic, a thermoplastic elastomer, etc. Although glass plate 116 and frame 118 are shown to have a generally rectangular configuration, the present invention is not limited thereby. Each side wall 120 of frame 118, as shown in cross-section, includes a long vertical wall section 122 which terminates at its lower end at a short outwardly directly horizontal wall section 124, and which in turn, terminates at its outer end at a short downwardly directed vertical foot wall section 126 that supports base 112 on a surface. Further, short horizontally oriented flanges 128 extend inwardly from the lower ends of long vertical wall sections 122 at positions higher than horizontal wall sections 124, the purpose for which will be better understood from the discussion which follows. Glass plate 116 is secured to base 112 at a position below flanges 128. In this regard, for example, glass plate 116 can be secured directly to the underside of flanges 128, as shown in FIGS. 4 and 5, or to the underside of horizontal wall sections 124, as shown in FIGS. 6-8.

A hydrophobic field 130 is provided on glass plate 116 to define a plurality of, for example, 1536, hydrophilic domains 132. Only some of the hydrophilic domains 132 are shown in FIG. 6 for the sake of brevity in the drawing. An array of droplets 134 is confined to hydrophilic domains 132 within hydrophobic field 130 on glass plate 116. Surface tension holds droplets 134 on glass plate 116.

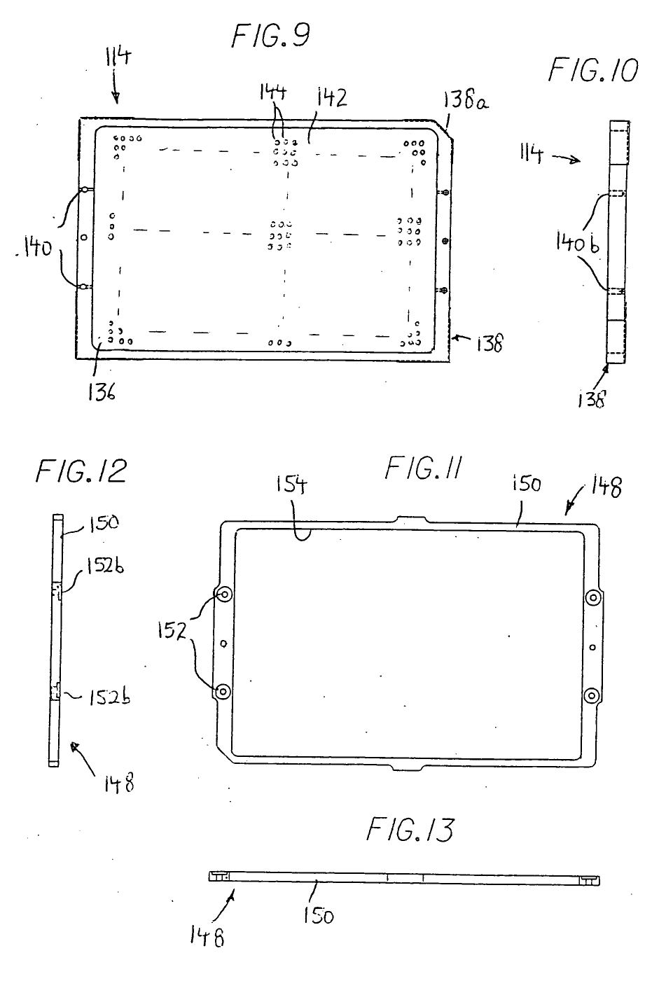

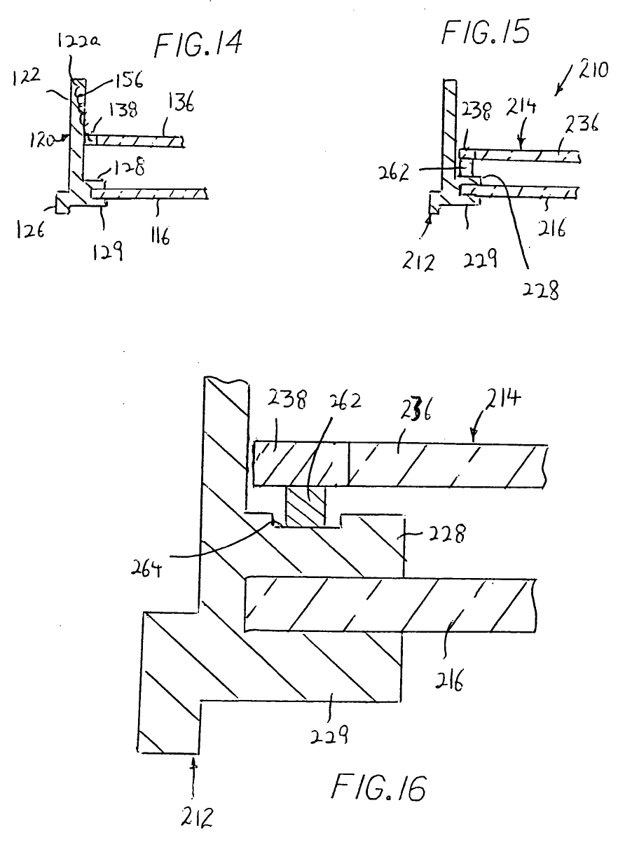

Virtual well plate system 110 further includes a lower movable lid 114 having a glass plate 136 provided in a frame 138 made of any suitable material, including but not limited to a metal such aluminum or steel, a plastic, a thermoplastic elastomer, etc. Although glass plate 136 and frame 138 are shown to have a generally rectangular configuration, the present invention is not limited thereby. The outer dimensions of frame 138 permit lid 114 to fit within frame 118 of base 112 and to slide vertically therein. Frame 138 includes two spring retaining elements 140 on each of the two opposing short walls. Each spring retaining element 140 can be any suitable device, such as an opening in frame 138, a hook or loop on frame 138, etc. for holding one end of a coil spring. Spring retaining element 140 is shown as a hook 140a in FIGS. 5 and 6, and as an opening 140b in FIGS. 9 and 10.

A hydrophobic field 142 is provided on glass plate 136 to define a plurality of, for example, 1536, hydrophilic domains 144 equal in number, dimensions and spacing to hydrophilic domains 132 on glass plate 116. Only some of hydrophilic domains 144 are shown in FIG. 9 for the sake of brevity in the drawing. An array of droplets 146 is confined to hydrophilic domains 144 within hydrophobic field 142 on glass plate 136. Surface tension holds droplets 146 in a hanging manner on glass plate 136.

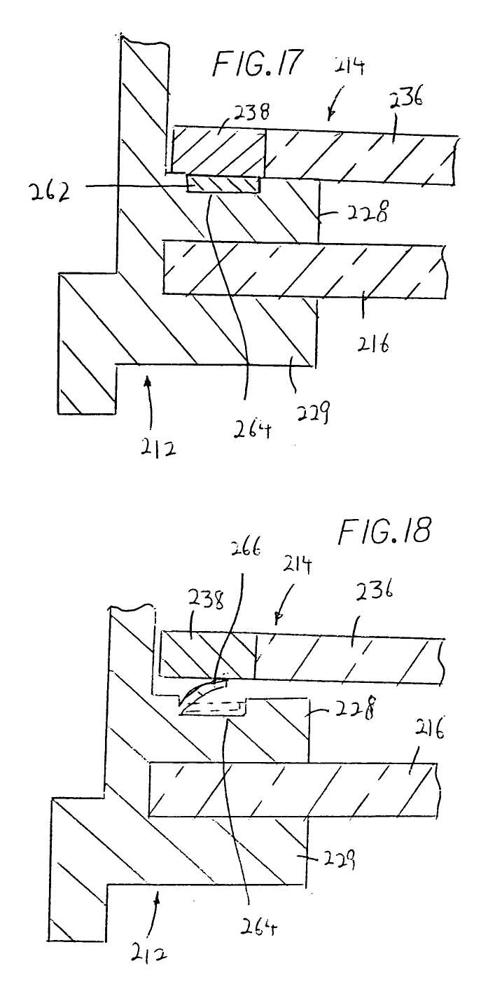

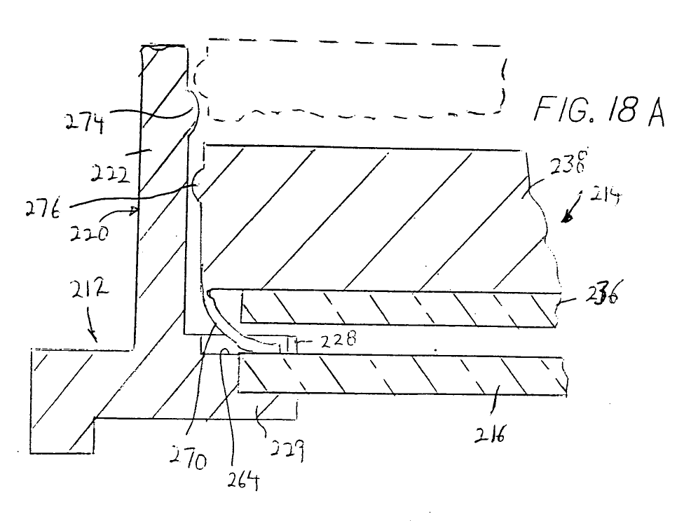

Virtual well plate system 110 further includes an upper stationary lid 148 comprised of a frame 150 made of any suitable material, including but not limited to a metal such aluminum or steel, a plastic, a thermoplastic elastomer, etc., and surrounding a central opening 154. Frame 150 has the same general outer dimensions as side walls 120 of base 112, and is immovably connected to the upper end of long vertical wall sections 122 of side walls 120. Frame 150 includes two spring retaining elements 152 on each of the two opposing short walls. Each spring retaining element 152 can be any suitable device, such as an opening in frame 150, a hook or loop on frame 150, etc. for holding one end of a coil spring. Spring retaining element 152 is shown as a hook 152a in FIGS. 5 and 6, and as an opening 152b in FIGS. 11-13.

Four coil springs 156 are connected between corresponding spring retaining elements 140 and 152, such that lower movable lid 114 is suspended above horizontally oriented flanges 128 of base 112, as shown in FIG. 4, for example, with a distance of 1.85 mm (0.073 inch) between glass plates 116 and 136. In this position, droplets 134 and 146 are separated from each other by a sufficient distance so as not to join together. Accordingly, base 112 and lower movable lid 114 can be prepared to form the virtual wells and can be assembled together, without actually forming the virtual wells. For example, lower movable lid 114 can be spring connected to upper stationary lid 148, and then droplets 146 can be formed on lower movable lid 114. Then, the assembly of lower movable lid 114 and upper stationary lid 148 would be lowered relative to base 112 such that lower movable lid 114 moves vertically down within side walls 120 of base 112, and upper stationary lid 148 rests on top of the upper edges of long vertical wall sections 122 of side walls 120 in order to suspend lower movable lid 114 in spaced relation above horizontally oriented flanges 128. In this regard, base 112 and lower movable lid 114 can be stacker loaded.

The entire assembly can then move along a conveyor in an automated process or can merely be placed manually in a machine such that an upper pressing assembly 158 extends downwardly through opening 154 in upper stationary lid 148 to push down lower movable lid 114 against the force of coil springs 156, until lower movable lid 114 rests on the upper surfaces of horizontally oriented flanges 128. The thickness of flanges 128 determines the spacing between glass plates 116 and 136, for example, 0.85 mm (0.034 inch). Upper pressing assembly, in a preferred embodiment, is formed by conventional pipette tips or tip holders.

Of course, it will be appreciated that droplets 134 and 146 are in alignment with each other. This can be accomplished, for example, by configuring the dimensions of lower movable plate 114 to have little or no play when sliding within base 112. In addition, as shown in FIGS. 6 and 9, frames 118 and 138 each have a beveled corner 118a and 138a, respectively, which require alignment of lower movable lid 114 in base 112 with a predetermined alignment.

When lower movable lid 114 is moved to the position shown in FIG. 5, the aligned droplets 134 and 146 touch to create short liquid columns or virtual wells 160. The hydrophobic masked regions 130 and 142 surrounding each virtual well 160 ensure that the liquid stays in each virtual well 160 and does not migrate or travel to adjacent virtual wells 160.

Thus, the present invention presents a virtual well plate system 110 that provides an accurate and controlled arrangement for combining base 112 and lower movable lid 114 to form virtual wells 160, and more particularly, that maintains base 112 and lower movable lid 114 in an assembled condition, ready for formation of virtual wells 160. In this regard, this embodiment of the present invention uses a conventional pair of patterned glass plates 116 and 136, while adding a secondary or upper stationary lid 148 which permits assembly of base 112 and lower movable lid 114, but which maintains base 112 and lower movable lid 114 spaced apart by springs 156. This simplifies the mechanism required to execute a kinetic addition. Merely pressing on lower movable lid 114 with a pipette head or similar mechanism overcomes the preload force of coil springs 156, and moves glass plate 136 of lower movable lid 114 down into close proximity with glass plate 116 of base 112 to form virtual wells 160. This can easily be accomplished within the darkened enclosure of the aforementioned Fluorometric Imaging Plate Reader system sold under the trademark AFLIPR@ by Molecular Devices Corporation, or any other similar reader, without the use of a specialized robot to move lower movable lid 114. Additionally, since lower movable lid 114 is contained within the standard envelope of base 112, which is a shallow well microplate, the assembly of base 112 and lower movable lid 114 can be loaded into the Fluorometric Imaging Plate Reader system using existing stackers and mechanisms.

Since existing virtual well plates are designed with 1536 well patterns, the improved spring-spaced plate of the present invention provides 1536 capabilities to the Fluorometric Imaging Plate Reader system, and provides near simultaneous formation of all 1536 virtual wells.

It will be appreciated that various modifications within the scope of the present invention can be made to virtual well plate system 110. For example, upper stationary lid 148 can be eliminated, and the upper ends of coil springs 156 can be connected to openings 122a in long vertical wall sections 122, as shown in FIG. 14. This modification also shows lower horizontally oriented flanges 129 below horizontally oriented flanges 128 and spaced therefrom, for holding lower glass plate 116. Thus, lower glass plate 116 is sandwiched between flanges 128 and 129.

It will be appreciated that the present invention is not limited to the coil spring arrangement of FIGS. 4-13 for maintaining glass plates 116 and 136 in the spaced apart relationship. Because the construction of virtual well plate system 110 may be difficult and/or expensive to construct, other simpler constructions are available, bearing in mind that the present invention is intended to cover the broad aspect of spacing apart glass plates 116 and 136 in a preassembled condition, followed by activation by bringing glass plates 116 and 136 closer together at a later time.

For example, a virtual well plate system 210 according to a second embodiment of the present invention is shown in FIG. 15 which will now be described, in which elements common to those of virtual well plate system 110 are identified by the same reference numerals, but augmented by 100, and therefore, a detailed explanation of these common elements will not be described. With virtual well plate system 210, base 212 is constructed in the same manner as base 110 of FIG. 14, with lower glass plate 216 sandwiched between flanges 228 and 229. However, in place of coil springs 156, at least one deformable spacer 262 is provided between lid 214 and flanges 228. Deformable structures 262 space glass plate 236 of lid 214 from glass plate 216 of base 212 by a distance of, for example, 1.85 mm, which is sufficient to prevent the touching of the different droplets and thereby to prevent the formation of the virtual wells, in the absence of a downward external force. Further, deformable spacers 262 can be secured to either base 212 or lid 214.

However, deformable spacers 262 are provided only at a portion of the perimeter of lid 214. This is because deformable spacers 262 are flattened when a downward external pressure is applied to lid 214, and space must be provided for the lateral expansion of deformable spacers 262.

In addition, it is preferable that deformable spacers 262 be provided in recesses 264 in the upper surfaces of flanges 228, as shown in the enlarged views of FIGS. 16 and 17. In this manner, lid 214 can be brought fully down into contact with the upper surface of flanges 228, to ensure an accurate spacing of, for example, 0.85 mm between glass plates 216 and 236. In this case, each deformable spacer 262 is sufficiently flattened to lie entirely within its respective recess 264.

It will be appreciated that there are numerous constructions for deformable spacers 262, and some examples of deformable spacers 262 that can be used will now be provided, bearing in mind that the present invention is not limited to these specific examples.

Deformable spacers 262 can be reversible (resilient) or irreversible (non-resilient) in accordance with a third embodiment of the present invention. FIG. 18 shows a reversible or resilient, deformable spacer 262 in the form of a cantilevered leaf spring 266 having an upwardly bowed shape. Cantilevered leaf spring 266 is preferably formed integrally as a single piece mold with base 212, and supports glass plate 236 of lid 214 in spaced relation above glass plate 216 of base 212 to prevent formation of the virtual wells. When lid 214 is pressed down, frame 238 of lid 214 presses down on cantilevered leaf spring 266 and forces cantilevered leaf spring 266 into a recess 264 of one flange 228, as shown by the dashed line in FIG. 18. When the force on lid 214 is removed, cantilevered leaf spring 266 pushes lid 214 upwardly in the original spaced apart relation with base 212. Of course, it will be appreciated that a plurality of such cantilevered leaf springs 266 are preferably provided in a plurality of such recesses 264.

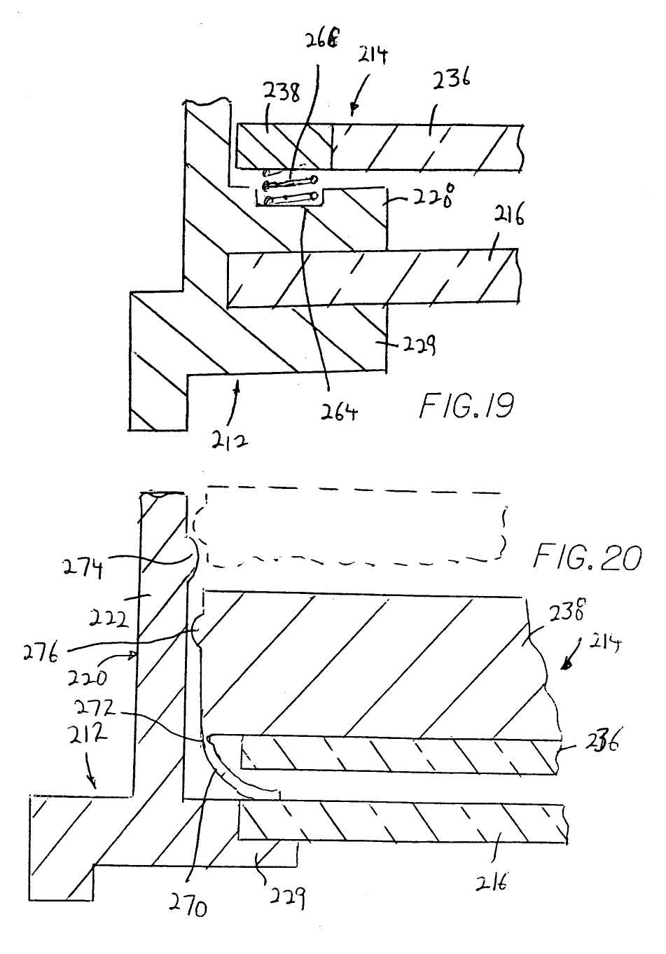

It will be appreciated that cantilevered leaf spring 266 can be formed integrally with frame 238 of lid 214 instead of being formed integrally with base 212, as shown in FIG. 18A. In such case, cantilevered leaf spring 266 will still compress into recess 264 during the formation of the virtual wells when lid 214 is pressed down. In addition, a detent arrangement 274, 276 can also be provided with this embodiment, in the manner taught by FIGS. 20, 28 and 29 hereafter. In this modification, glass plate 236 of lid 214 rests on the upper surfaces of flanges 228 in the lowered position for formation of the virtual wells.

FIG. 19 shows a modification of the arrangement of FIG. 18, in which each cantilevered leaf spring 266 is replaced by a coil spring 268 as another example of a reversible or resilient, deformable spacer 262.

FIG. 20 shows a further modification of the arrangement of FIG. 18, in which each cantilevered leaf spring 270 is integrally formed as a single piece in a molding operation at the lower edge of the frame 238 of lid 214 and connected thereat by a living hinge 272. In this embodiment, cantilevered leaf spring 270 functions as deformable spacer 262. In addition, however, flanges 228 are eliminated so that lower glass plate 216 is mounted on flanges 229, and cantilevered leaf springs 270 have the additional function of spacing apart glass plates 216 and 236 by a distance of, for example, 0.85 mm when lid 214 is pushed down. Thus, cantilevered leaf springs 270 serve the dual purpose of maintaining glass plates 216 and 236 sufficiently apart to prevent formation of the virtual wells when no downward force is applied to lid 214, and also as a precise spacer between glass plates 216 and 236 when an external downward force is applied to lid 214.

In addition, in the embodiment of FIG. 20, detents 274 are formed on the inner surfaces of long vertical wall sections 222 of side walls 220 of base 212, and detents 276 are formed on the outwardly facing surfaces of frame 238 of lid 214, in substantial vertical alignment with detents 274. Thus, when initially assembled, lid 214 is pushed slightly down until detents 276 ride over detents 274, so that lid 214 moves from the dashed line position to the solid line position in FIG. 20, such that lid 214 is supported by cantilevered leaf springs 270 and glass plate 236 is supported in spaced relation from glass plate 216 to prevent formation of the virtual wells. Further downward pressure on lid 214 results in the bending of cantilevered leaf springs 270 until cantilevered leaf springs 270 are sandwiched between glass plates 216 and 236 in order to separate these plates by a predetermined distance of, for example, 0.85 mm, for formation of the virtual wells.

In order to remove lid 214 after formation of the virtual wells, a special tool (not shown) can be used. This can be, for example, a simple hook that enters an opening in frame 238, is rotated and then pulls up on lid 214. Alternatively, a vacuum gripper or the like can be used to remove lid 214.

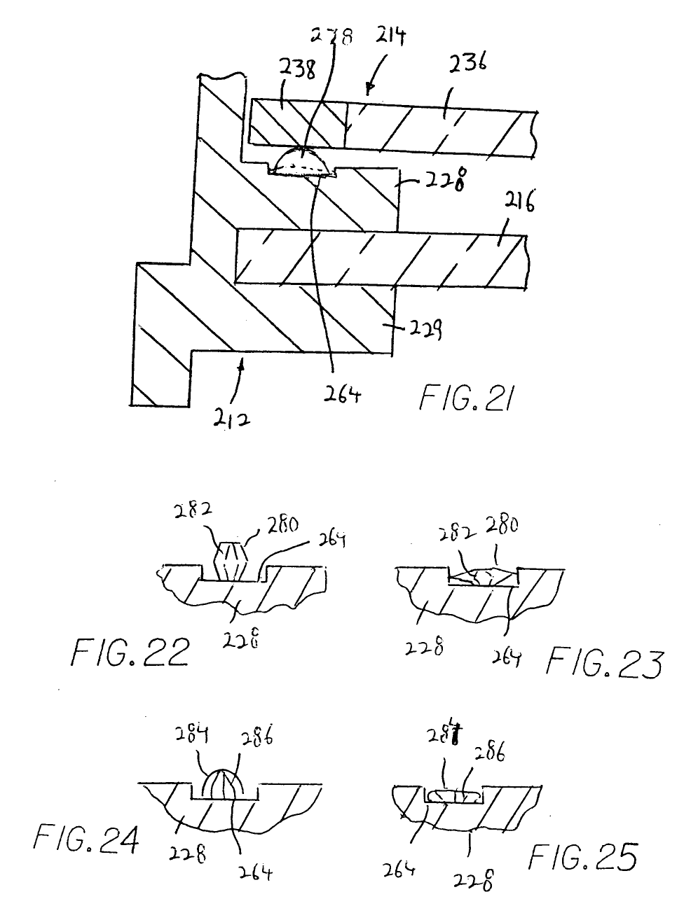

As discussed above, deformable spacers 262 can be irreversible, that is, not resilient, so that it does not return to its initial position when the force on lid 214 is removed. FIG. 21 shows an irreversible or non-resilient, deformable spacer 262 in the form of a deformable projection 278 formed in recess 264 and extending above the upper surface of flange 228. Deformable projection 278 is shown in a hemispherical shape, but the present invention is not limited thereby. Deformable projection 278 can be formed of any suitable non-Newtonian material such as plastic, paste, gel, gum, foam, etc. which is sufficient to support lid 214 but maintain it separate and apart from base 212, but which is irreversibly squashed or compressed to the dashed line position, when a downward force is applied to lid 214. Thus, when lid 214 is initially assembled with base 212, deformable projections 278 retain lid 214 in the raised solid line position of FIG. 21, and when a sufficient downward force is applied to lid 214, projections 278 are irreversibly crushed to the dashed line position so that lid 214 rests on the upper surface of flanges 228.

Irreversible or non-resilient, deformable spacers 262 can take other forms, such as that of a Chinese lantern projection 280, as shown in FIG. 22, which has a plurality of vertical slits 282. When a downward force is applied to lid 214, Chinese lantern projections 280 are crushed to the position shown in FIG. 23 so as to fit entirely in recesses 264.

Irreversible deformable spacers 262 can take other forms, such as that of a slitted hemispherical dome or bubble projection 284, as shown in FIG. 24, which has a plurality of vertical slits 286. When a downward force is applied to lid 214, slitted dome projection 284 is crushed to the position shown in FIG. 25 so as to fit entirely in recess 264. Other shapes such as spheres, other shell shapes, etc. can also be used.

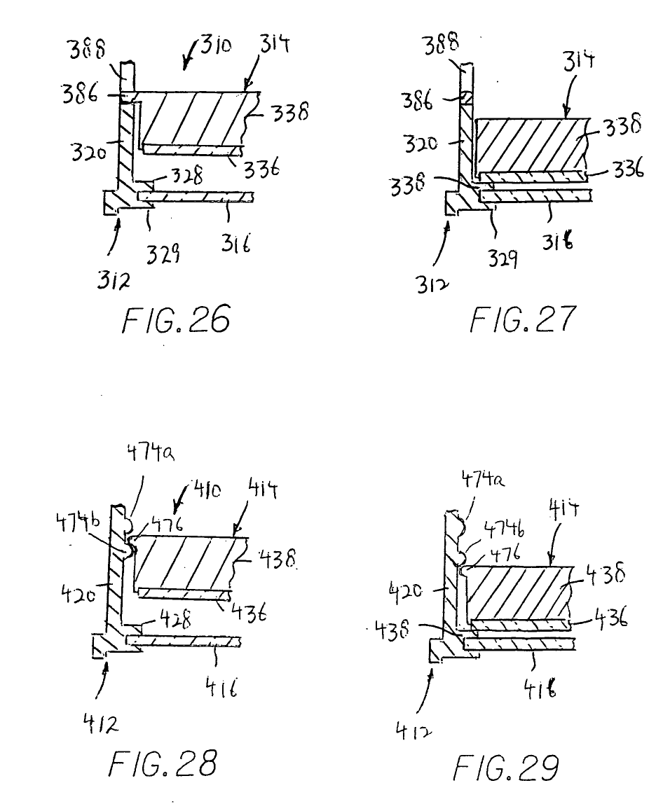

Referring now to FIG. 26, a virtual well plate system 310 according to a fourth embodiment of the present invention includes a base 312 which is identical with base 212 of FIG. 15 such that lower glass plate 316 is sandwiched between flanges 328 and 329 which extend inwardly from side walls 320. However, in order to support lid 314 such that upper glass plate 336 is spaced away from lower glass plate 316 so as not to form the virtual wells, frame 338 of lid 314 includes outwardly extending break-away tabs 386 that rest in open slots 388 at the upper ends of side walls 320 such that glass plate 336 is in spaced relation from glass plate 316 to prevent formation of the virtual wells.

When a downward force is applied to lid 314, tabs 386 break away from frame 338 and remain in open slots 388, while lid 314 is forced down against the upper surface of flanges 328 in order to form the virtual wells, as shown in FIG. 27. Alternatively, a breakaway mechanism with similar behavior can be constructed such that the stationary and breakaway sections are originally attached with an adhesive, magnets, a snap-fit, or Velcro or a similar hook and eye system.

Referring now to FIG. 28, a virtual well plate system 410 according to a fifth embodiment of the present invention will now be described. Virtual well plate system 410 is similar to virtual well plate system 210 of FIG. 20, except that cantilevered leaf spring 270 is eliminated, and there are two vertically spaced apart upper and lower detents 474a and 474b formed on each of the inner surfaces of long vertical wall sections 422 of side walls 420 of base 412, and detents 476 are formed on the outwardly facing surfaces of frame 438 of lid 414, in vertical alignment with detents 474. Thus, when initially assembled, detents 476 of lid 414 rest on upper detents 474a, or alternatively, lid 414 can be pushed slightly down until detents 476 pass over upper detents 474a and are trapped between upper detents 474a and lower detents 474b, as shown in FIG. 28, such that glass plate 436 of lid 414 is supported in spaced relation from glass plate 416 to prevent formation of the virtual wells. Further downward pressure on lid 414 results in detents 476 riding over lower detents 474b so that lid 414 rests on flange 428, as shown in FIG. 29, in order to separate plates 416 and 436 by a predetermined distance of, for example, 0.85 mm, for formation of the virtual wells.

In order to remove lid 414 after formation of the virtual wells, a special tool (not shown) can be used. This can be, for example, a simple hook that enters an opening in frame 438, is rotated and then pulls up on lid 414. Alternatively, a vacuum gripper or the like can be used to remove the lid.

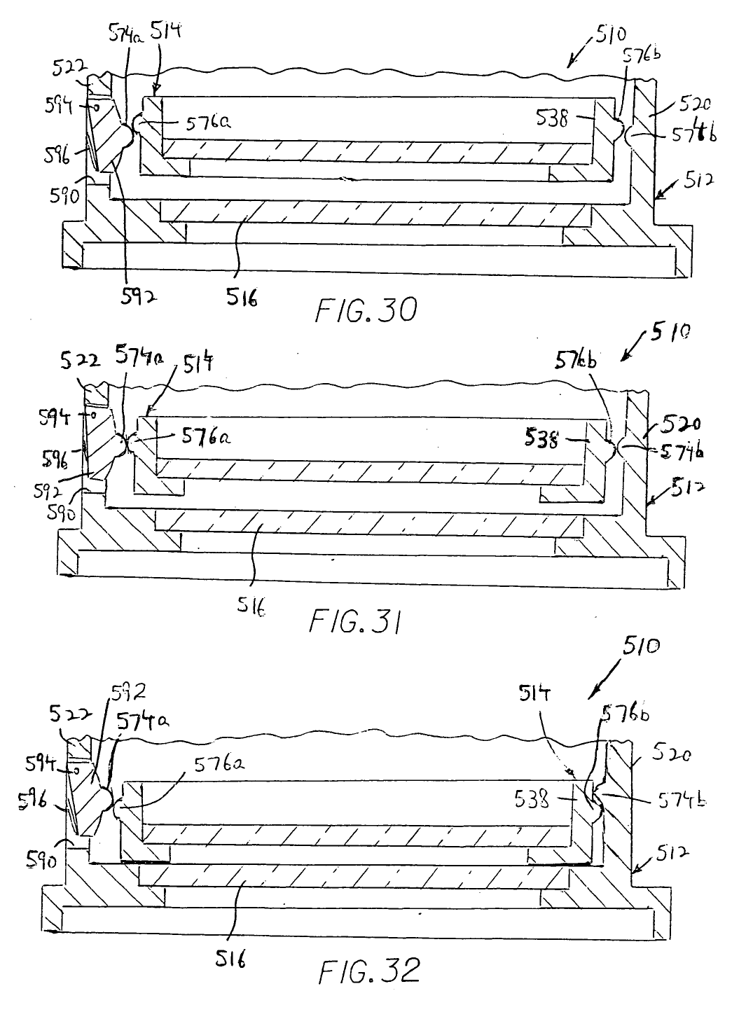

Referring now to FIG. 30, a virtual well plate system 510 according to a sixth embodiment of the present invention will now be described. Virtual well plate system 510, as with other embodiments described above, maintains upper glass plate 536 of lid 514 in spaced relation above lower glass plate 516 until it is time to form the virtual wells, but in addition, biases lid 514 laterally in an X-Y direction to one side of base 512 so as to more accurately align lid 514 with base 512.

In this regard, long vertical wall sections 522 of two adjacent side walls 520 of base 512 each include at least one opening 590, and a cam lever 592 is positioned in each opening 590 and pivotally mounted by a pivot pin 594 at the upper end of opening 590. A spring 596, which can be a leaf spring (as shown), coil spring, torsion spring or the like, normally biases each cam lever 592 inwardly of base 512. A detent 574a is provided on the inner surface of each cam lever 592, and a detent 576a is provided on the outer surface of frame 538 of lid 514 that faces cam lever 592, and is in vertical alignment with detent 574a. A detent 574b is provided on the inner surface of the side wall 520 which is opposite to cam lever 592, and a detent 576b is provided on the outer surface of frame 538 that faces detent 574b, and is in vertical alignment with detent 574b.

In this manner, as shown in FIG. 30, detents 574a and 574b engage detents 576a and 576b to support lid 514 in such a manner that upper glass plate 536 is in spaced relation from lower glass plate 516 to prevent the formation of the virtual wells. The spring force of springs 596 is sufficient to hold lid 514 in this position. When a downward external force is applied to lid 514, lid 514 moves downwardly, thereby pivoting cam lever 592 in the clockwise direction to the position shown in FIG. 31. During this movement, cam lever 592 is still applying a lateral force to lid 514 to move lid 514 to the right in FIG. 31 and thereby align glass plate 536 of lid 514 with glass plate 516 of base 512.

At the time when detents 576a and 576b pass or ride over detents 574a and 574b, the spring force of springs 596 move cam levers 592 in the counter-clockwise direction to the position shown in FIG. 32 in which the detent 576b is forced against the inner surface of side wall 520 which represents the zero reference. Cam levers 592 still apply a lateral force to lid 514, and also apply a slight downward force on lid 514 to retain lid 514 in position on base 512 for formation of the virtual wells. To remove lid 514 at a later time, lid 514 is merely pulled upwardly, and a reverse operation occurs with cam levers 592. It will be appreciated that, in this embodiment, a lower extension 538a of frame 538 is sandwiched between glass plates 516 and 536, and forms the spacer for spacing these glass plates apart by a predetermined distance, for example, 0.85 mm, for formation of the virtual wells.

It will be appreciated that cam levers 592 are preferably provided on two adjacent side walls 520, with detents 574b being provided on the opposing two side walls 520 so as to provide biasing of lid 514 in the lateral X-Y directions to obtain X-Y alignment to a zero reference position.

Although spring activated cam lever 592 is shown as being pivoted about a pivot pin 594, it will be appreciated that cam lever 592 can be pivoted at a living hinge, and thereby be integral with base 512. As a further modification, the hinge or pivot point for cam lever 592 can be at the bottom of opening 590 of base 512, as opposed to the top which is shown in FIG. 32.

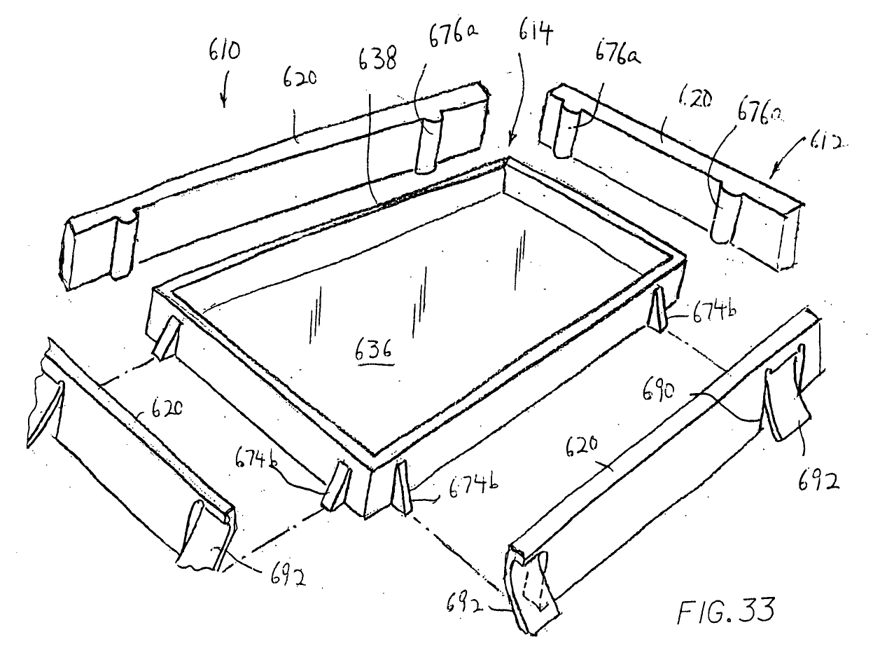

A modification of the sixth embodiment is shown in FIG. 33 in which a virtual well plate system 610 includes a lid 614 having an upper glass plate 636 held by an outer frame 638, with the outwardly facing surfaces of frame 638 having wedges 674b on two adjacent walls thereof, which increase in depth from top to bottom. Base 612 is shown in an exploded view with the side walls 620 separated for better understanding. Two adjacent side walls 620 each include two cantilevered leaf springs 692 that are hinged at upper ends thereof and extend through openings 690 in side walls 620.

It will be appreciated that leaf springs 692 are shown biased outwardly for the sake of better explanation, but will normally be biased inwardly. The spring force from leaf springs 692 is sufficient to hold lid 614 so that upper glass plate 636 thereof is spaced from the lower glass plate (not shown) of the base to prevent formation of the virtual wells, in the absence of an external downward actuating force on lid 614.

In addition, leaf springs 692 interact with wedges 674b to bias lid 614 in the lateral X-Y directions. Because of the increase in depth of wedges 674b, lid 614 is gradually pushed in the X and Y directions until the remaining two side walls of frame 638 abut against columnar stops 676a on the inner surfaces of side walls 620 that do not contain leaf springs 692. The downward force on lid 614 prevents lid 614 from raising up from base 612. In this position, upper glass plate 636 of lid 614 is separated from the lower glass plate (not shown) of base 612 by a predetermined distance of, for example, 0.85 mm.

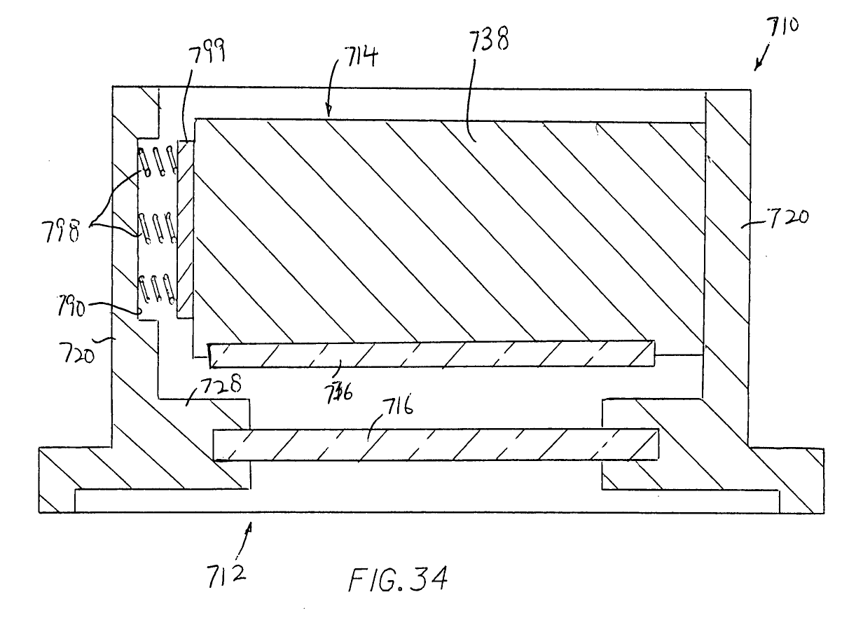

A further modification of the sixth embodiment is shown in FIG. 34 in which a virtual well plate system 710 includes a lid 714 having an upper glass plate 736 held by an outer frame 738, and a base 712 holding a lower glass plate 716. Long vertical wall section 722 of one side wall 720 has a recess 790 that houses a plurality of coil springs 798 which push against a guide plate 799 that is restrained to move only to the left and right in FIG. 34. The specific restraining walls for guide plate 799 are not shown for the sake of brevity in the drawing.

Thus, when lid 714 is pushed down, frame 738 slides against the inner surface of guide plate 799, which by reason of coil springs 798 biases lid 714 to the right in FIG. 34 against the inner surface of the opposite side wall 720. This serves the dual purpose of accurately aligning upper glass plate 736 of lid 714 relative to lower glass plate 716 of base 712, and also of holding lid 714 in the position shown in FIG. 34 by friction until a further downward force is applied thereto, whereupon lid 714 slides down such that upper glass plate 736 rests on flanges 728 of base 712. As a result, there is zero offset between lid 714 and base 712.

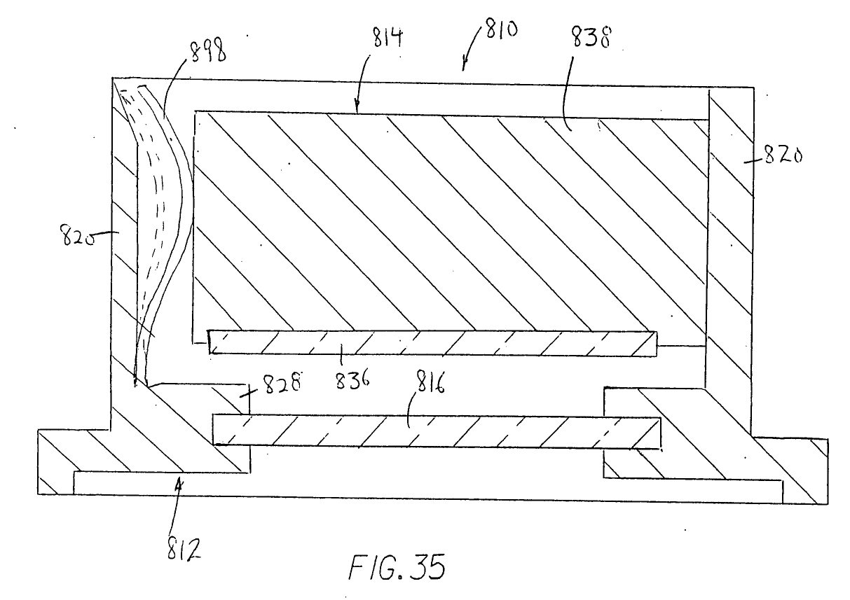

A further modification of the sixth embodiment is shown in FIG. 35 in which a virtual well plate system 810 includes a lid 814 having an upper glass plate 836 held by an outer frame 838, and a base 812 holding a lower glass plate 816. An elongated, arcuately bowed leaf spring plate 898 is secured at its lower end to the corner between one flange 828 and one side wall 820, and extends upwardly adjacent the inner surface of long vertical wall section 822 of the one side wall 820. Thus, when lid 814 is pushed down, frame 838 slides against bowed leaf spring 898 which biases lid 814 to the right in FIG. 35 against the inner surface of the opposite side wall 820. This serves the dual purpose of accurately aligning upper glass plate 836 of lid 814 relative to lower glass plate 816 of base 812, and also of holding lid 814 in the position shown in FIG. 35 by reason of the bowed spring nature of leaf spring 898 until a further downward force is applied thereto, whereupon lid 814 slides down such that upper glass plate 836 rests on flange 828 of base 812. As a result, there is zero offset between lid 814 and base 812.

It will be appreciated that any other suitable resistance arrangement can be used which is mounted to the base and/or the lid and which maintains the base and lid in an assembled condition such that the base plate and lid plate are maintained at a sufficient distance to prevent formation of virtual wells by the droplets thereon, but which permits movement of the lid toward the base to form the virtual wells upon application of an external force sufficient to overcome the resistance of the resistance arrangement. This can even be accomplished by a simple friction fit between the lid and base.

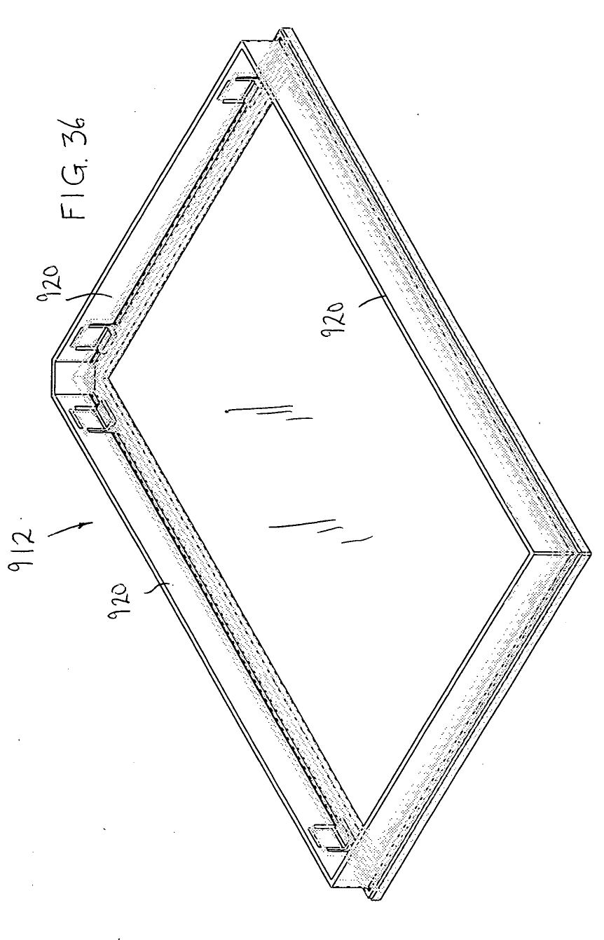

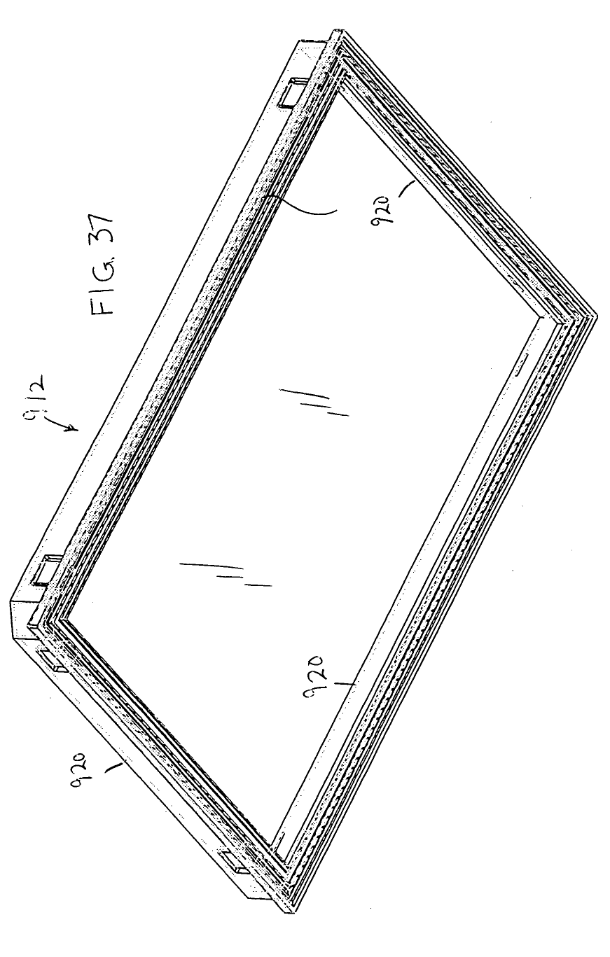

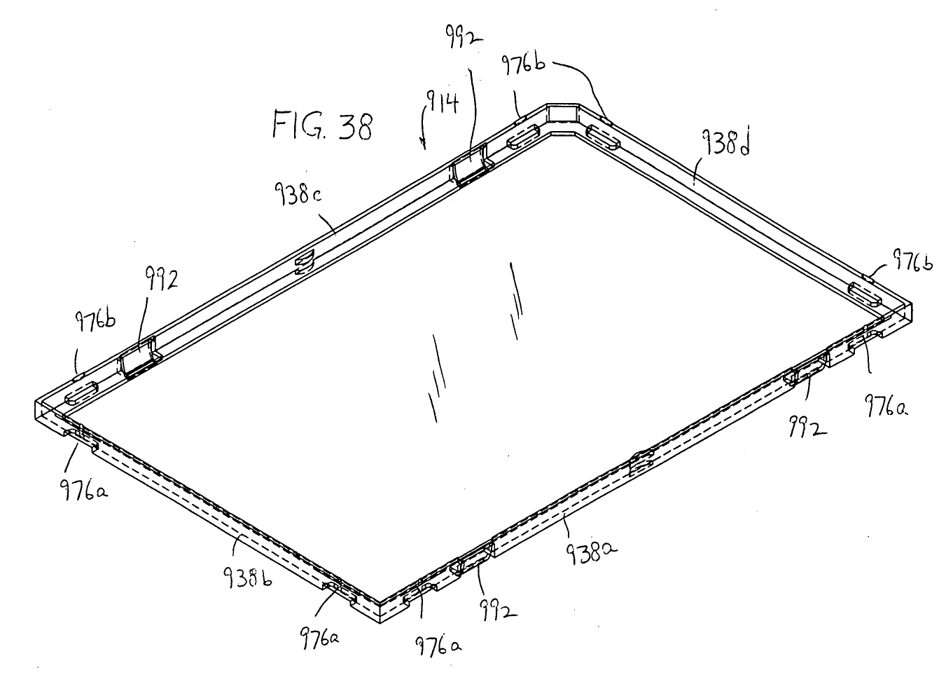

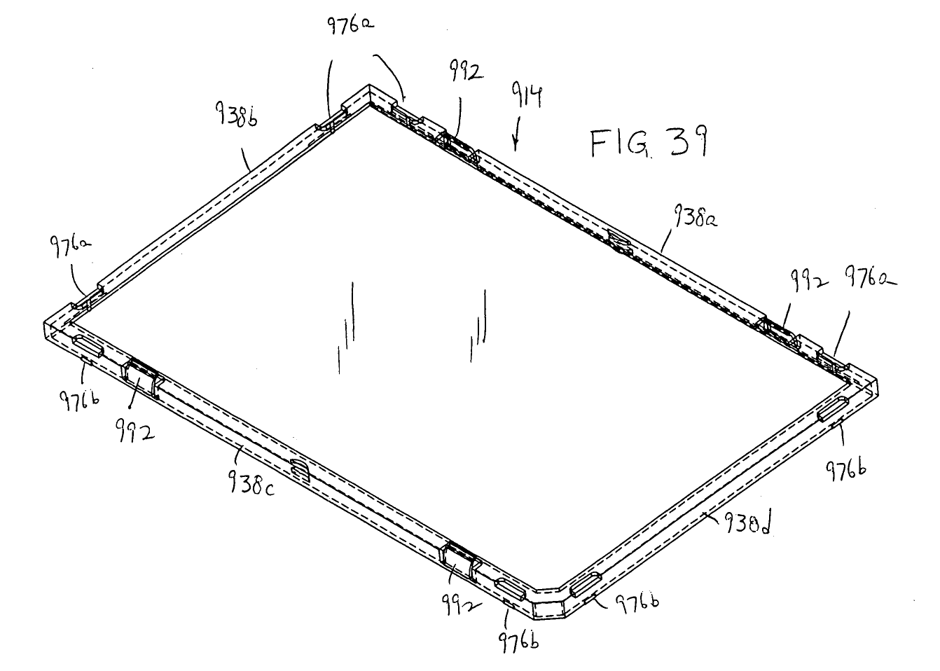

FIGS. 36-39 show a modification of the above embodiments, and effectively is a combination of the embodiments of FIGS. 20 and 30-32. Specifically, there is a base 912 which constitutes an outer frame and a lid 914 that constitutes an inner frame that fits within base 912. One pair of adjacent side walls 938a and 938b of base 912 is more rigid than the other two adjacent side walls 938c and 938d of base 912, and flexing of the weaker pair of side walls 938c and 938d forces the inner frame to the zero reference against the inner surfaces of the side walls 920 of base 912 corresponding to the same side walls 938a and 938b of lid 914. Wider bumps or detents 976a on the stiffer walls 938a and 938b provide the differential stiffness. Narrower bumps or detents 976b are provided on the weaker walls 938c and 938d, and pivoted separating springs 992 on opposing side walls 938a and 938c keep lid or inner frame 914 more than 0.85 mm away from base or outer frame 912. The virtual wells are not shown in FIGS. 36-39 for the sake of clarity in the drawings.

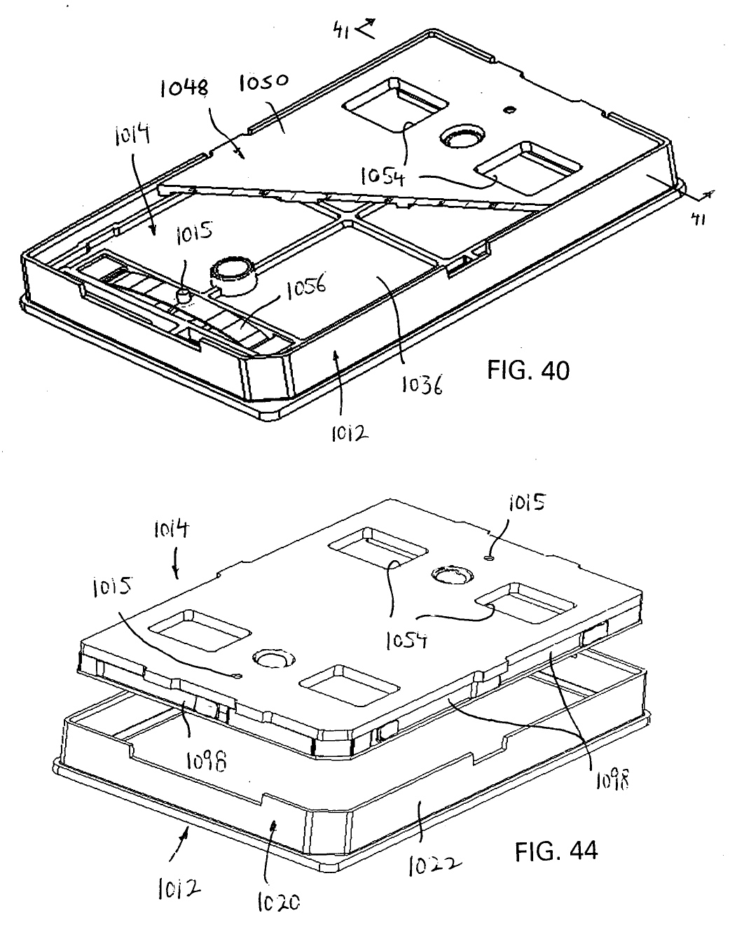

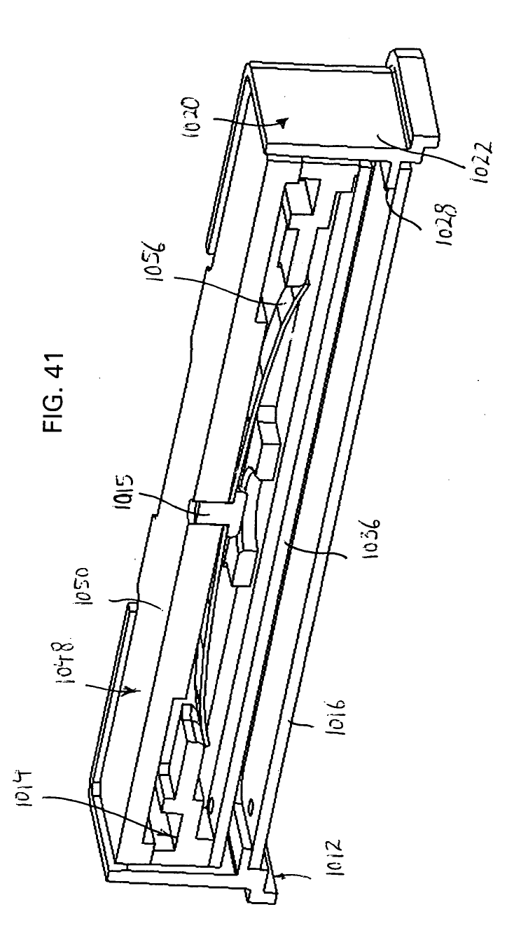

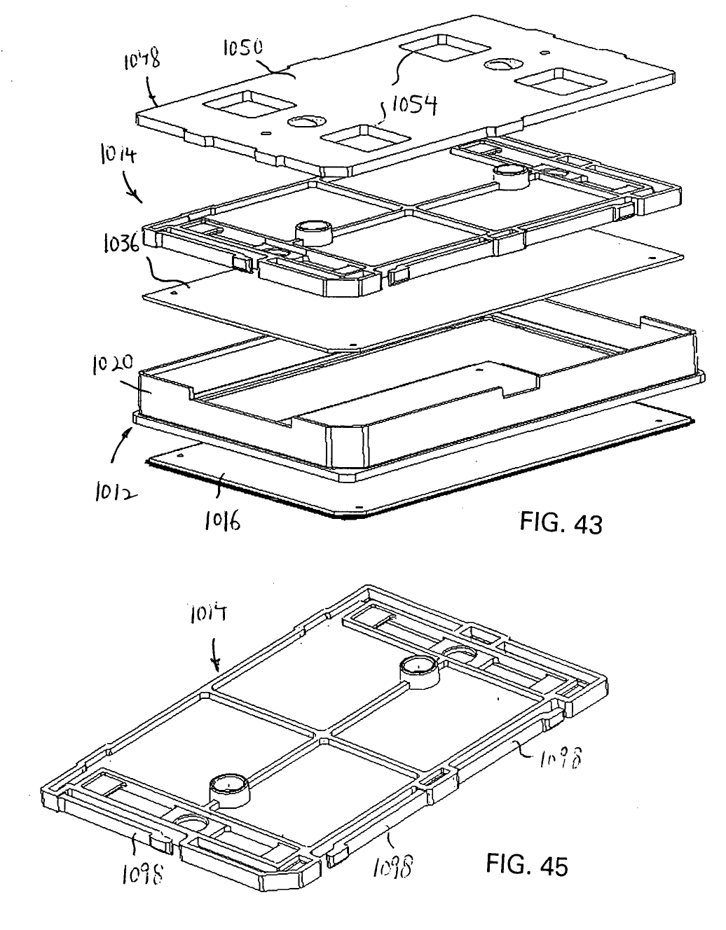

FIGS. 40-45 show a virtual well plate system according to a modification of the present invention, which is similar to the embodiment of FIG. 4. Specifically, there is a base 1012 which constitutes an outer frame and a lower movable lid 1014 that constitutes an inner frame that fits within base 1012. Base 1012 has a glass plate 1016 secured thereto at a position below inwardly directed flanges 1028 of base 1012. In like manner, lid 1014 has a glass plate 1036 secured thereto. As shown best in FIGS. 40-42, rather than using four coil springs as in FIG. 4, this embodiment uses two flat, convex bent, springs 1056, one at each end. The opposite ends of each flat spring 1056 mounted to lid 1014 at center positions thereof are secured to a rivet 1015 to upper stationary lid 1048 which is immovably connected to the upper end of long vertical wall sections 1022 of side walls 1020 of base 1012. In this manner, lower movable lid 1014 is suspended above horizontally oriented flanges 1028 of base 1012, as shown best in FIG. 41, with a distance of, for example, 1.85 mm (0.073 inch) between glass plates 1016 and 1036. In this position, the droplets (not shown) on the plates are separated from each other by a sufficient distance so as not to join together.

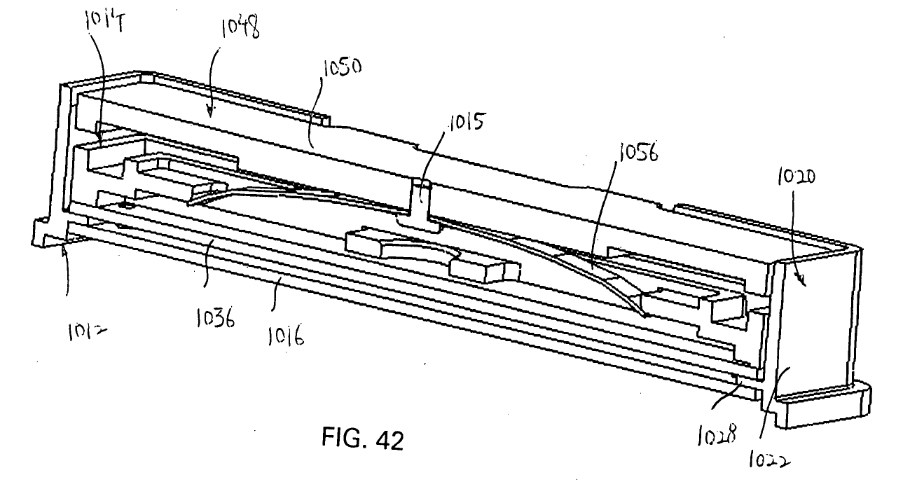

Upper stationary lid 1048 includes an upper wall 1050 having a plurality of, for example, four, access openings 1054 which serve the same function as central opening 154 in FIG. 4, but which limit user access to movable lid 1014, and provide better protection against accidental actuation. In this manner, an upper pressing assembly (not shown) can extend downwardly through openings 1054 to push down lower movable lid 1014 against the force of flat springs 1056, until glass plate 1036 of lower movable lid 1014 rests on the upper surfaces of horizontally oriented flanges 1028, as shown in FIG. 42, with a predetermined spacing between glass plates 1016 and 1036 which his determined by the thickness of horizontally oriented flanges 1028.

In addition, x-y registration spring arms 1098 are formed in a cantilevered manner at two adjacent side walls of movable lid 1014, and the free ends of which engage the inner surfaces of long vertical wall sections 1022 of side walls 1020 of base 1012. In this manner, the wells on base 1012 and lid 1014 are aligned with each other.

It will be appreciated that certain assays are near real-time kinetic, and do not require the time course to be recorded from the onset through the peak response and resolution of the response. Yet it is difficult to make additions of agonist to the plate simultaneously at 1536 and higher well counts. The spring (or otherwise separated) plate can be used with these readers, in conjunction with a simple electromechanical or pneumatic plunger device to actuate the plate just prior to the loading into the detection system. This would require the “actuate, remain actuated” embodiment.

It will be appreciated that virtual wells are not only hydrophilic wells in a hydrophobic field, but are any surface modification, etc. that orders or retains drops in a defined spatial array. Thus, the simultaneous addition of the present invention is a feature of any two plate virtual well plate system, and also applies to all plate densities. In this manner, the addition can be after assembly and upon actuation of the invention.

It will further be appreciated that in all of the above embodiments, alignment, cam operation, and detent functions can be either on the lid or the base.

Further, various features from different embodiments can be combined. For example, the X-Y alignment feature and the cam action can be combined with the detents, and are not restricted to a friction type system.

It will further be appreciated that the present invention can be made of any suitable material. For example, the entire assembly can be made entirely of plastic, with the virtual wells using textured areas of the lid. In such case, the lid would have molded-in features for the detents and springs.

Preferably, there would be one base compatible with three lids, namely, a first lid that has no resistance elements, a second lid that has a resilient element and detents and a third lid that simply has detents. This would allow the same base to be ordered for use as a standard virtual well plate, with a machine that can actively hold down the lid, and one that needs the lid to remain down after being actuated by an external device.

Having described specific preferred embodiments of the invention with reference to the accompanying drawings, it will be appreciated that the present invention is not limited to those precise embodiments and that various changes and modifications can be effected therein by one of ordinary skill in the art without departing from the scope or spirit of the invention as defined by the appended claims.

### Parts Designator List

10 known virtual well plate system
12 base
14 lower movable lid
16 glass plate
18 frame
20 hydrophobic field
22 hydrophilic domains
24 droplets
26 short liquid columns or virtual wells
110 virtual well plate system
112 base
114 lower movable lid
116 glass plate
118 frame
188a beveled corner
120 side wall
122 long vertical wall section
122a opening
124 horizontal wall section
126 vertical foot wall section
128 horizontally oriented flange
129 horizontally oriented flange
130 hydrophobic field
132 hydrophilic domains
134 droplets
136 glass plate
138 frame
138a beveled corner
140 spring retaining elements
140a hook
140b opening
142 hydrophobic field
144 hydrophilic domains
146 droplets
148 upper stationary lid
150 frame
152 spring retaining elements
152a hook
152b opening
154 central opening
156 coil springs
158 upper pressing assembly
160 virtual wells
210 virtual well plate system
212 base
214 lid
216 lower glass plate
220 side walls
222 long vertical wall sections
228 flange
229 flange
236 glass plate
238 frame
262 deformable spacer
264 recess
266 cantilevered leaf spring
268 coil spring
270 cantilevered leaf spring
272 living hinge
274 detents
246 detents
278 deformable projection
280 Chinese lantern projection
282 vertical slits
284 slitted dome hemispherical projection
286 vertical slits
310 virtual well plate system
312 base
314 lid
316 upper glass plate
320 side walls
328 flange
329 flange
336 upper glass plate
338 frame
386 outwardly extending break-away tabs
388 open slots
410 virtual well plate system
412 base
414 lid
416 glass plate
420 side wall
428 flange
436 glass plate
438 frame
474a upper detent
474b lower detent
476 detent
510 virtual well plate system
512 base
514 lid
516 lower glass plate
520 side walls
522 long vertical wall section
536 upper glass plate
538 frame
574a detent
574b detent
576a detent
576b detent
590 opening
592 cam lever
594 pivot pin
596 spring
610 virtual well plate system
612 base
614 lid
620 side walls
636 upper glass plate
638 frame
674b wedges
676a columnar stops
690 openings
692 springs
710 virtual well plate system
712 base
714 lid
716 lower glass plate
720 side walls
722 long vertical wall section
728 flange
736 upper glass plate
738 outer frame
790 recess
798 coil springs
799 guide plate
810 virtual well plate system
812 base
814 lid
816 lower glass plate
820 side walls
822 long vertical wall section
828 flange
836 upper glass plate
838 outer frame
898 cantilevered leaf spring
912 base
914 lid
920 side wall
838a side wall
838b side wall
938c side wall
938d side wall
976a detents
976b detents
992 springs
1012 base
1014 lid
1015 rivet
1016 glass plate
1020 side walls
1022 long vertical wall sections
1028 inwardly directed flanges
1036 glass plate
1048 upper stationary lid
1050 upper wall
1054 access openings
1056 springs
1098 x-y registration spring arms

1. A virtual well plate system comprising:
a base including a base plate having an upper surface with a hydrophobic region which defines a plurality of hydrophilic domains on the upper surface of the base plate, each hydrophilic domain adapted to hold a droplet of liquid therein;
a movable lid including a lid plate having a lower surface with a hydrophobic region which defines a plurality of hydrophilic domains on the lower surface of the lid plate, each hydrophilic domain of the lid plate adapted to hold a droplet of liquid therein in a hanging manner; and
a resistance arrangement mounted to at least one of the base and the lid which maintains the base and lid in an assembled condition such that the base plate and lid plate are maintained at a sufficient distance to prevent formation of virtual wells by the droplets thereon, and which permits movement of the lid toward the base upon application of an external force sufficient to overcome a resistance of the resistance arrangement in order to form the virtual wells by a combination of the droplets on the base plate and the lid plate

2. A virtual well plate system according to claim 1, wherein the resistance arrangement includes at least one spring which supports the movable lid above the base.

3. A virtual well plate system according to claim 2, further comprising a stationary lid mounted to said base, and the at least one spring is connected between the stationary lid and the movable lid for supporting the movable lid above the base.

4. A virtual well plate system according to claim 3, wherein the at least one spring includes a plurality of springs selected from the group of coil springs and flat springs connected between the stationary lid and the movable lid.

5. A virtual well plate system according to claim 3, wherein the stationary lid includes at least one opening through which an external pressing device can be inserted for biasing the movable lid toward the base against the force of the at least one spring.

6. A virtual well plate system according to claim 2, wherein the base includes at least one upstanding side wall, and the at least one spring includes a plurality of coil springs connected between upper ends of the at least one side wall and the movable base.

7. A virtual well plate system according to claim 1, wherein the resistance arrangement includes a deformable spacer between said lid and said base.

8. A virtual well plate system according to claim 7, wherein the deformable spacer includes a resilient member.

9. A virtual well plate system according to claim 8, wherein the deformable spacer includes at least one spring positioned between the base and the lid.

10. A virtual well plate system according to claim 9, wherein the at least one spring is connected to one of the base and the lid.

11. A virtual well plate system according to claim 10, wherein each spring includes a cantilevered leaf spring connected to said one of the base and the lid.

12. A virtual well plate system according to claim 11, wherein the cantilevered leaf spring is positioned between the base and the lid when the lid is moved toward the base by the external force, so as to maintain the base plate and the lid plate separated by a predetermined distance sufficient to form the virtual wells.

13. A virtual well plate system according to claim 7, wherein the base includes a recess for receiving the deformable spacer.

14. A virtual well plate system according to claim 7, wherein the deformable spacer includes a non-resilient member.

15. A virtual well plate system according to claim 14, wherein the non-resilient member includes a crushable member which is crushed when the external force is applied to the lid.

16. A virtual well plate system according to claim 15, wherein the crushable member includes slits for permitting easy crushing thereof.

17. A virtual well plate system according to claim 1, wherein the base includes at least one peripheral flange having an upper surface, and the base plate includes an upper surface which is positioned lower than the upper surface of the at least one peripheral flange such that, when the lid is moved by the application of the external force sufficient to overcome the resistance of the resistance arrangement, the at least one peripheral flange maintains a lower surface of the lid plate at a predetermined distance from the upper surface of the base plate for formation of the virtual wells.

18. A virtual well plate system according to claim 17, wherein the at least one peripheral flange includes a recess in the upper surface thereof for holding said resistance arrangement and for permitting said resistance arrangement to collapse entirely in said recess such that the lid rests on the upper surface of the at least one peripheral flange when the lid is moved by the application of the external force sufficient to overcome the resistance of the resistance arrangement.

19. A virtual well plate system according to claim 1, wherein said base includes at least one upstanding side wall and said lid is slidably positioned within said at least one upstanding side wall.

20. A virtual well plate system according to claim 19, wherein said resistance arrangement includes at least one first detent on an inner surface of the at least one upstanding side wall and at least one second detent on an outer surface of said lid for engagement with said at least one first detent such that the at least one first detent supports the lid plate at a sufficient distance from the base plate to prevent formation of the virtual wells by the droplets thereon, and which permits movement of the lid plate toward the base plate upon application of an external force sufficient to overcome resistance of the at least one second detent riding over the at least one first detent in order to form the virtual wells by a combination of the droplets on the base plate and the lid plate.

21. A virtual well plate system according to claim 20, wherein there are two substantially vertically aligned first detents and one second detent which is captured between said two first detents to maintain the lid plate at a sufficient distance from the base plate to prevent formation of the virtual wells by the droplets thereon.

22. A virtual well plate system according to claim 1, wherein the resistance arrangement includes at least one laterally movable spring biased element mounted to the base for applying a lateral force to the lid to maintain the lid plate at a sufficient distance from the base plate to prevent formation of the virtual wells by the droplets thereon and to also laterally align the lid plate relative to the base plate, and which permits movement of the lid plate toward the base plate with said lateral alignment upon application of an external force sufficient to overcome resistance of the laterally movable spring biased element in order to form the virtual wells by a combination of the droplets on the base plate and the lid plate.

23. A virtual well plate system according to claim 22, wherein the base includes at least one upstanding side wall, and each laterally movable spring biased element includes a cam lever pivotally mounted to at least one upstanding side wall and a spring for biasing said cam lever inwardly of said base.

24. A virtual well plate system according to claim 23, wherein each said upstanding side wall to which at least one said cam lever is pivotally mounted includes at least one opening therein, and each said cam lever is pivotally mounted to the base and is positioned in a respective said opening.

25. A virtual well plate system according to claim 24, wherein each said cam lever includes a first detent on an inner facing surface thereof, and said lid includes at least one second detent on an outer facing surface thereof for engagement with each said first detent.

26. A virtual well plate system according to claim 22, wherein each laterally movable spring biased element includes a guide plate and at least one spring which biases the guide plate inwardly of the base in a lateral direction so as to maintain the base and lid in an assembled condition by the force of the guide plate on the lid such that the base plate and lid plate are maintained at a sufficient distance to prevent formation of the virtual wells by the droplets thereon, and which permits movement of the lid plate toward the base plate upon application of an external force sufficient to overcome frictional resistance between the guide plate and the lid in order to form the virtual wells by a combination of the droplets on the base plate and the lid plate.

27. A virtual well plate system according to claim 22, wherein the base includes at least one upstanding side wall, at least one upstanding side wall includes an opening therein, and each laterally movable spring biased element includes a cantilevered leaf spring hinged to the base and positioned in a respective said opening.

28. A virtual well plate system according to claim 27, further comprising a wedge element on an outer surface of the lid in association with each cantilevered leaf spring such that downward movement of the lid by the external force causes engagement between each cantilevered leaf spring and associated wedge to laterally move the lid plate into lateral alignment with the base plate.

29. A virtual well plate system according to claim 22, wherein each laterally movable spring biased element includes an upstanding cantilevered leaf spring having an inwardly bowed configuration and extending upwardly from said base between the upstanding side wall of the base and the lid for laterally biasing the lid when the lid plate is moved toward the base plate.

30. A virtual well plate system according to claim 22, wherein the base includes a plurality of connected upstanding side walls, and there are a plurality of said laterally movable spring biased elements mounted to two adjacent upstanding side walls for laterally aligning the lid relative to the base.

31. A virtual well plate system according to claim 1, further comprising at least one laterally movable spring biased element mounted to the base for applying a lateral force between the lid and the base to laterally align the lid plate relative to the base plate.

32. A virtual well plate system according to claim 31, wherein the at least one laterally movable spring biased element is provided at least one adjacent side walls of one of the following:
a) the lid, and
b) the base.

33. A virtual well plate system according to claim 31, wherein each laterally movable spring is selected from the group consisting of:
a) a coil spring,
b) a cantilevered spring, and
c) a biased pivoted member.
